(19) United States
(12) Patent Application Publication
(10) Pub. No.: US 2025/0062438 A1
(43) Pub. Date: Feb. 20, 2025

(54) HEAT EXCHANGER PLATE FOR BATTERY PACK

(71) Applicant: Valeo Systemes Thermiques, Le Mesnil-Saint-Denis (FR)

(72) Inventors: Donald Boyd, Le Mesnil-Saint-Denis (FR); Christian Casenave, Le Mesnil-Saint-Denis (FR); Didier Fourreau, Le Mesnil-Saint-Denis (FR)

(73) Assignee: Valeo Systemes Thermiques, Le Mesnil-Saint-Denis (FR)

(21) Appl. No.: 18/452,301

(22) Filed: Aug. 18, 2023

(51) Int. Cl. H01M 10/6554; F28F 21/08; H01M 10/625; H01M 10/6556

(52) U.S. Cl. CPC H01M 10/6554; F28F 21/089; H01M 10/625; H01M 10/6556; F28F 2275/04; H01M 2220/20

(57) ABSTRACT

A heat exchanger plate, for thermal management of one or more battery packs, includes a base plate including a first core material and a lower coating layer. A channel plate is disposed adjacent to the base plate, the channel plate including at least one channel formed therein and a second core material different from the first core material. The base plate and channel plate combine to define an inlet, an outlet, and a conduit for propagating heat transfer fluid. The first core material is stronger than the second core material and the lower coating layer enhances brazing of the base plate to the channel plate. A related battery unit includes a battery pack and the heat exchanger plate. A related method includes forming the base plate and channel plate, brazing the base plate to the channel plate, and propagating heat transfer fluid between the inlet and outlet via the conduit.

### BACKGROUND

As electric and hybrid vehicles gain in prominence, unique challenges continue to be presented in the thermal regulation of batteries and battery packs utilized therewith. For instance, colder temperatures can significantly impact battery charge and limit the range of a vehicle, while excessively high temperatures can present a risk of thermal runaway and subsequent destruction of the battery.

Conventionally, battery temperature may be regulated by circulating one or more heat transfer fluids, such as air or water, in a conduit circuit. The conduit circuit passes under or within a heat exchanger plate that itself is in direct contact with the batteries. The heat transfer fluids thus cool the batteries by absorbing the heat they emit, and evacuating the heat to one or more one or more heat exchangers such as a radiator or a cooler. The heat transfer fluids can also help heat the batteries when needed.

Generally, a heat exchanger plate may be formed from two stamped metal plates that are brazed to each other. Between the plates, one or more channels are formed for propagating heat transfer fluid between an inlet and an outlet.

To physically protect the batteries from external forces or perturbations, a structural element including beams, crosspieces and other elements is usually provided, e.g., adjacent to both the batteries and heat exchanger plate. In so doing, a significantly high mechanical strength (e.g., a very high yield strength and ultimate strength) is normally sought. However, this normally entails significant cost considerations along with added weight that itself may compromise the full operating potential of the batteries themselves. Particularly, the added weight simply adds to the overall weight of the vehicle and thereby have a negative impact on battery range. In this connection, the use of stronger materials is often sought for heat exchanger plates, yet this is just as often discouraged by undesirable tradeoffs in operability that can be involved.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a heat exchanger plate for thermal management of one or more battery packs. The heat exchanger plate includes a base plate including a first core material and a lower coating layer that coats the first core material. A channel plate is disposed adjacent to the base plate, the channel plate including at least one channel formed therein and a second core material different from the first core material. The base plate and channel plate combine to define an inlet, an outlet, and a conduit for propagating heat transfer fluid between the inlet and the outlet. The first core material is stronger than the second core material and the lower coating layer enhances brazing of the base plate to the channel plate.

In one aspect, embodiments disclosed herein relate to a battery unit for a hybrid or electric vehicle. The battery unit includes a battery pack and a heat exchanger plate for thermal management of the battery pack. The heat exchanger plate includes a base plate including a first core material and a lower coating layer that coats the first core material. A channel plate is disposed adjacent to the base plate, the channel plate including at least one channel formed therein and a second core material different from the first core material. The base plate and channel plate combine to define an inlet, an outlet, and a conduit for propagating heat transfer fluid between the inlet and the outlet. The first core material is stronger than the second core material and the lower coating layer enhances brazing of the base plate to the channel plate.

In one aspect, embodiments disclosed herein relate to a method including: providing a first core material and coating the first core material with a lower coating layer to form a base plate; and providing a second core material different from the first core material, the first core material being stronger than the second core material, to form a channel plate with at least one channel disposed therein, wherein the lower coating layer enhances brazing of the base plate to the channel plate; brazing the base plate to the channel plate, wherein the base plate and channel plate combine to define an inlet, an outlet, and a conduit; and propagating heat transfer fluid between the inlet and outlet via the conduit.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 provides an exploded, isometric view of components of a battery pack and related components in accordance with one or more embodiments.

FIG. 2 schematically illustrates components of a heat exchanger plate, in accordance with one or more embodiments.

FIGS. 3-7 each provide essentially the same view as FIG. 2, while depicting various material configurations that may be employed, in accordance with one or more embodiments.

FIG. 8 shows a flowchart of a method in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Broadly contemplated herein, in accordance with one or more embodiments, is a heat exchanger plate for the thermal management of one or more batteries or battery packs, formed in such a manner as to impart appreciable structural strength on its own, and thus facilitating the inclusion of a lighter structural element adjacent, while still maintaining sufficient thermal regulation properties. At the same time, such an arrangement manages to avoid undesirable tradeoffs such as a loss of functionality, such as brazeability, in connection with core materials utilized.

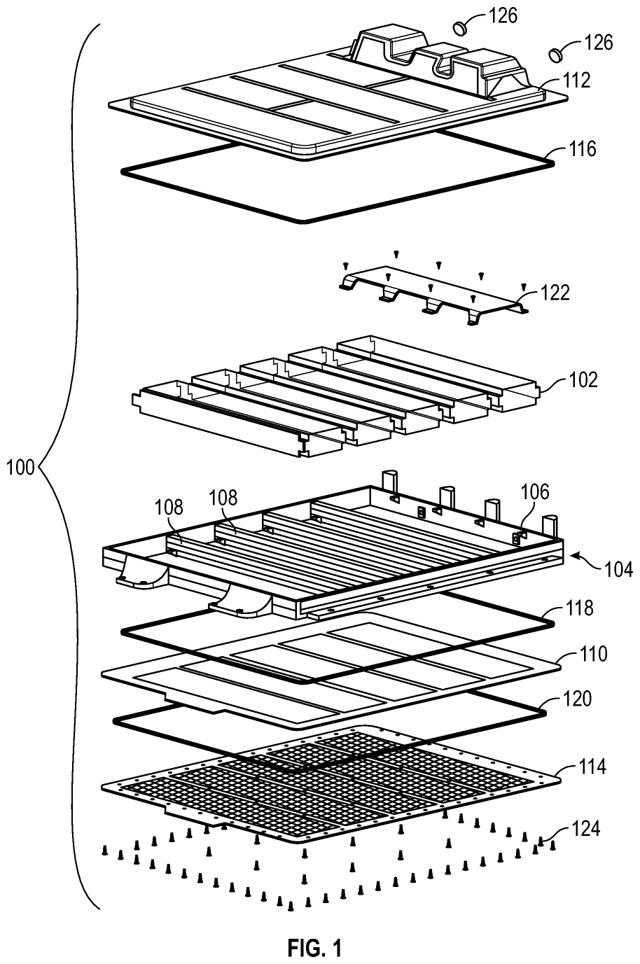

FIG. 1 provides an exploded, isometric view of components of a battery pack and related components in accordance with one or more embodiments. It should be understood that FIG. 1 provides but one illustrative example of a context in which a heat exchanger plate may be employed.

As shown, in accordance with one or more embodiments, a battery unit 100 includes a battery pack or set of batteries 102 that may be supported by a structural element 104. A “battery pack”, “set of batteries” or “battery set”, as discussed herein, may refer to an electrically interconnected set of battery cells (or what may be considered individual “batteries”) that together form the “set” or “pack”, or otherwise a single large battery. In the present working example, the set 102 shown in FIG. 1 is an interconnected set of batteries or cells.

In accordance with one or more embodiments, structural element 104 includes a rectangular frame 106 and individual crosspieces 108 extending between the longer sides of frame 106. In the present working example, four such crosspieces 108 are shown. Thus, individual batteries (or cells) in the set 102 may each be each located in a “slot” defined between adjacent crosspieces 106.

In accordance with one or more embodiments, a heat exchanger plate 110 may be disposed adjacent to the batteries 102 and structural element 104. Other components in the “stack” constituting battery unit 100 may include an upper cover 112 and a lower cover 114. Adhesive layers 116, 118 and 120 may be provided, respectively, between upper cover 112 and structural element 104 (with battery set 102), between structural element 104 (with battery set 102) and heat exchanger plate 110, and between heat exchanger plate 110 and lower cover 114. Support 122 for a BMS (battery management system) may also be disposed between structural element 104 (with battery set 102) and upper cover 112, while a face plate 124 may be appended to a side of lower cover 114 opposite from the heat exchanger plate 110. Finally, venting valves 126 may be provided for the upper cover 112.

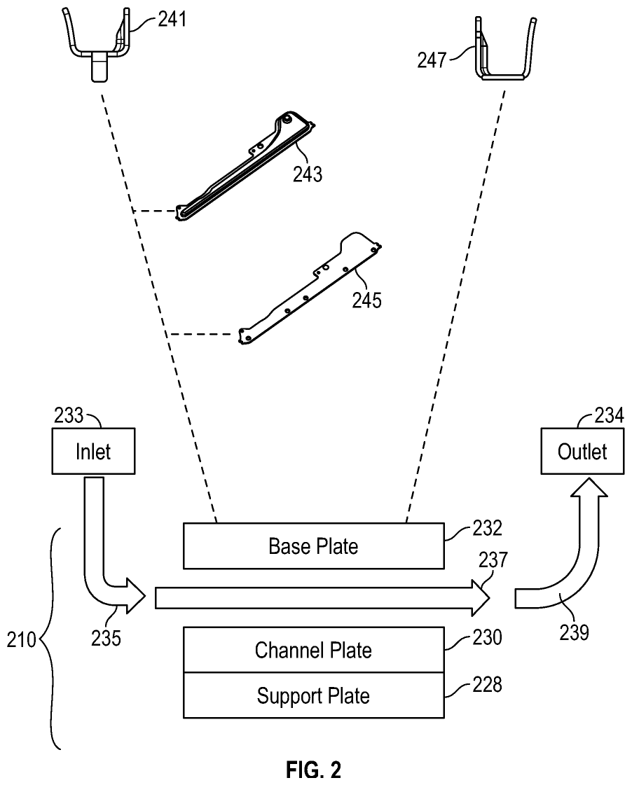

FIG. 2 schematically illustrates components of a heat exchanger plate, in accordance with one or more embodiments. Thus, without limitation, the heat exchanger plate 210 shown in FIG. 2 may be utilized in an operating context such as that shown for the heat exchanger plate 110 in FIG. 1.

As shown in FIG. 2, in accordance with one or more embodiments, heat exchanger plate 210 includes a support plate 228, a channel plate 230 and a base plate 232. Channel plate 230 includes a plurality of channels formed therein (e.g., via stamping), but essentially laid out as a single, meandering or tortuous path (or conduit) with numerous turns and curves.

In accordance with one or more embodiments, and as schematically illustrated in FIG. 2, channel plate 230 combines with base plate 232 to define a single path (or conduit) from an inlet 233 to an outlet 234. Thus, heat exchanger fluid enters the heat exchanger plate 210 through the inlet 233 and an associated inlet channel 235, progresses through the heat exchanger plate via the noted internal channels (as indicated generally via arrow 237), and exits the heat exchanger plate 210 through an outlet channel 239 and the associated outlet 234. Thus, the noted conduit may be considered to include the inlet channel 235, internal channels 237 and outlet channel 239. Support plate 228, for its part, is not involved in the transmission of any liquid and simply provides a measure of structural support; accordingly, it may be considered an optional component in one or more embodiments.

As also shown in exploded fashion, a U-shaped inlet-side busbar holder 241 may be included to extend into the interior of heat exchanger plate 210 on the side of plate 210 that includes the inlet 233, and includes structural components 243 and 245. Additionally, a U-shaped outlet-side busbar holder 247 may be included to extend to the from the interior of heat exchanger plate 210 on the side of plate 210 that includes the outlet 234. Busbar holders 241 and 247 are each configured to hold a busbar within the U-shaped cross-section, and rest on other components of the heat exchanger plate 210. Thus, busbar holders 241 and 247 are coated in a manner to be described below, to provide thermal insulation between the busbars and the noted other components of heat exchanger plate 210. For their part, components 243 and 245 are constituent parts of an additional distributor/manifold for handling and distributing and collecting fluid between the inlet and channels 235/239 (through the holes shown in component 245).

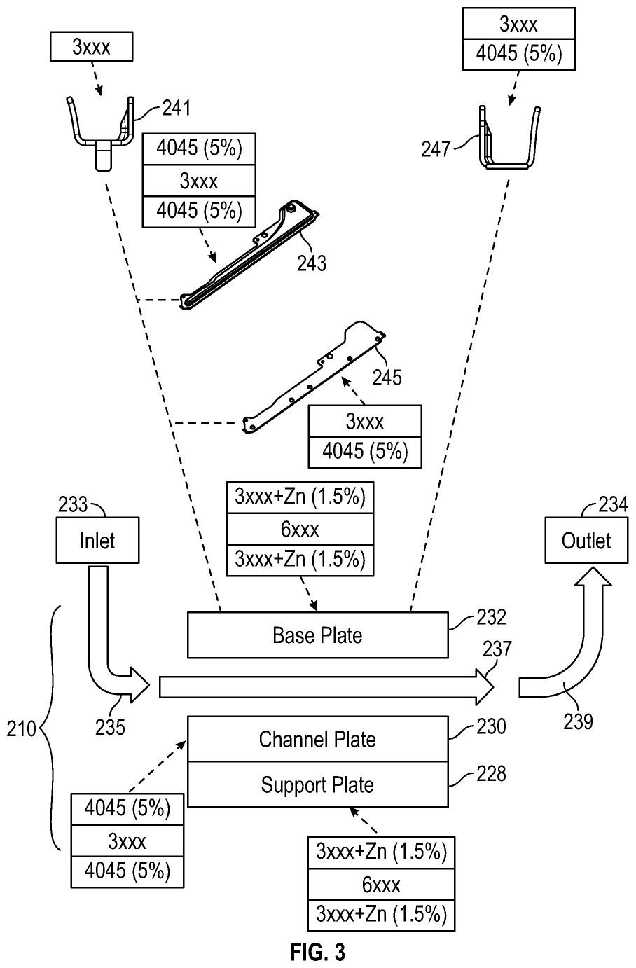

In accordance with one or more embodiments, as now will be described, each of the structural components shown in FIG. 2 may be formed from one or more layers of material. Thus, this applies to the inlet-side busbar holder 241, components 243 and 245, support plate 228, channel plate 230, base plate 232 and outlet-side busbar holder 247. The disclosure thus now turns to FIGS. 3-7, depicting various material configurations that may be employed, utilizing wrought aluminum alloys in the materials.

Accordingly, in accordance with one or more embodiments, reference will be made to aluminum alloys identified via the four-digit wrought aluminum alloy designation system. Particularly, the first digit corresponds to a main alloying element, the second digit corresponds to a modification of a specific alloy, and the third and fourth digits provide identifying numbers corresponding to different alloys in a series. If the second through fourth digits include an “x”, then the four-digit designation is not specific to any particular alloy in the series indicated by the first digit. In discussing such alloys herebelow, the main alloying element is conveyed in parentheses, e.g., 3xxx (manganese).

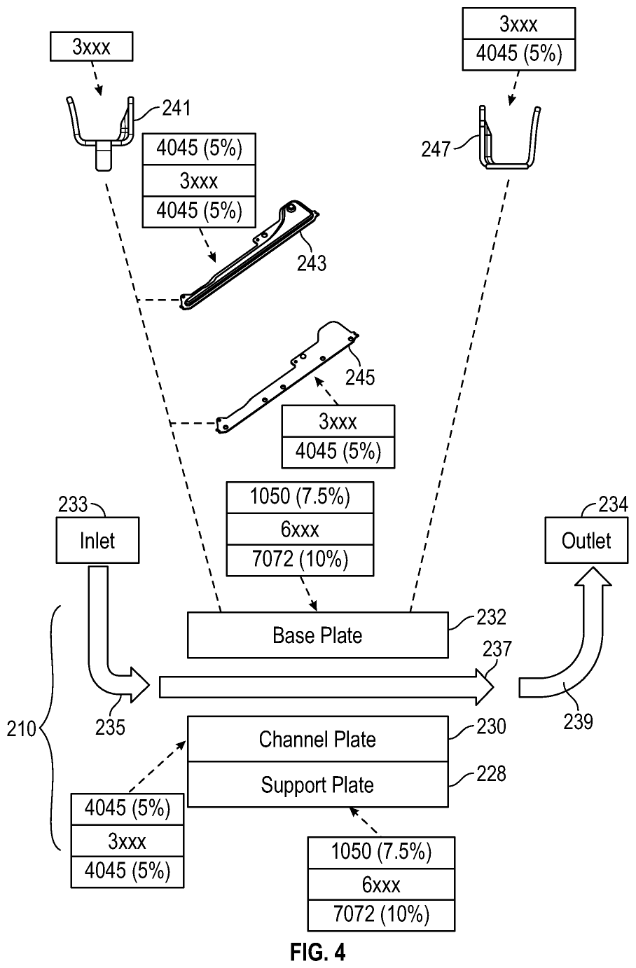

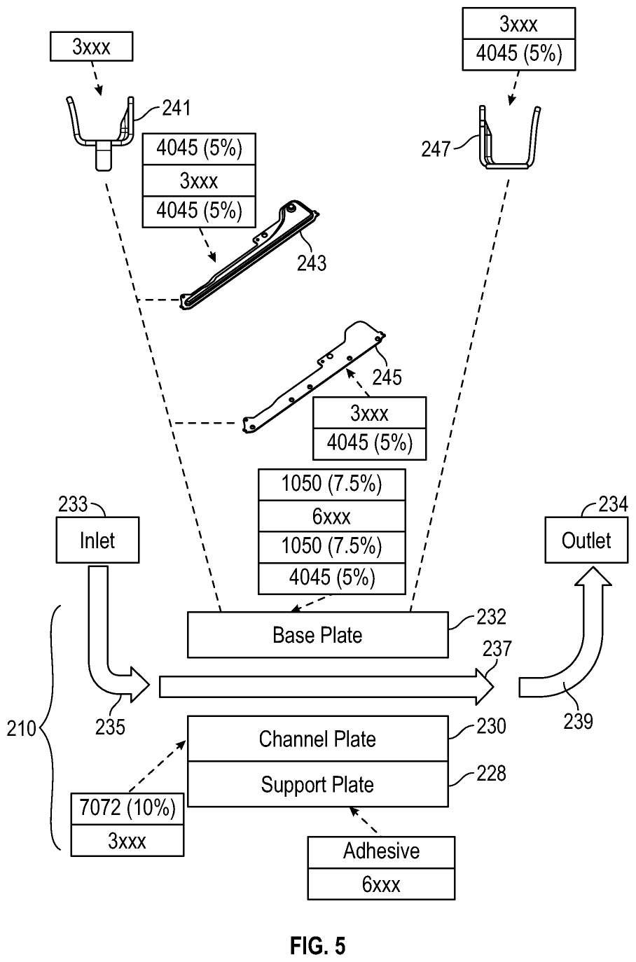

In accordance with one or more embodiments, across all configurations discussed with respect to FIGS. 3-7, each of the noted structural components may be formed with one or more layers of material, including a “core” layer and (if not single-layered) either or both of “upper” and “lower” coating layers (relative to each figure and to other components in the figure). Further, in accordance with illustrative and non-restrictive working examples, each of the plates 228, 230 and 232 may have a thickness in the range of about 0.5 mm to 2.0 mm. Merely by way of example, the inlet-side busbar holder 241, components 243 and 245, and outlet-side busbar holder 247 may each have a thickness of about 1.0 mm. Additionally, base plate 232 and channel plate 230 may each have a thickness of about 0.8 mm. Further, support plate 228 may have a thickness of about 1.5 mm in the first two configurations discussed below (FIGS. 3 and 4) or about 1.0 mm in the third, fourth and fifth configurations discussed below (FIGS. 5-7).

In accordance with one or more embodiments, a first configuration shown in FIG. 3 provides favorable corrosion resistance and brazeability for components of heat exchanger plate 210. Thus, in the first configuration, a 3xxx alloy (manganese) is utilized specifically for brazeability and alloy 1050 (at least 99.5% aluminum) is utilized specifically for corrosion resistance. Additionally, alloy 4045 (silicon) is used as a brazing material. At the same time, and as will be appreciated, a 6xxx alloy (magnesium and silicon) can in places substitute for a 3xxx alloy as a core material to provide greater strength, including enhanced post-brazing mechanical properties, insofar as it can be coated with material conducive to enhanced brazeability. The designations 3xxx and 6xxx may also be referred to as 3 series alloys and 6 series alloys.

In accordance with one or more embodiments, in the first configuration, inlet-side busbar holder 241, components 243 and 245 and outlet-side busbar holder 247 are each formed with a 3xxx alloy as a core layer. Brazing material (alloy 4045) is applied to both sides of the core layer for component 243, and to the lower side of the core layer for component 245; in each case, the layer of brazing material accounts for about 5% of the total thickness of the component in question. Additionally, base plate 232 and support plate 228 are each formed with a 6xxx alloy (magnesium and silicon) as a core layer while channel plate 230 is formed from a 3xxx alloy (manganese) as a core layer. Brazing material (alloy 4045) is applied to both sides of the core layer of channel plate 230 at 5% thickness. On the other hand, a coating formed from a 3xxx alloy and zinc is applied to both sides of the core layer of base plate 232 and support plate 228.

Thus, in accordance with one or more embodiments, the use of a 6xxx alloy as core material for base plate 232 and support plate 228 helps increase the overall strength of heat exchanger plate 210. Particularly, it can substitute for a 3xxx alloy in both cases, which itself cannot often meet requirements above 70 mPa. Additionally, artificial aging may enhance the strengthening properties of a 6xxx alloy, and can be considered in utilizing a 6xxx alloy as illustrated, tailored to the needs of a specific operating context. At the same time, it can be appreciated that the coating layers of base plate 232 and support plate 228, utilizing a 3xxx alloy and zinc, themselves can enhance brazeability to a degree that otherwise might be sacrificed for the lack of a core formed from a 3xxx alloy. It should also be appreciated here that an advantage of using zinc in the manner shown is enhanced corrosion protection; the amount of zinc can be tailored depending on the specific 3xxx alloy used (e.g., to tailor to any related needs for corrosion protection). Finally, it should be appreciated that the use of a 6xxx alloy may generally be considered to employ a more complex process than the use of a 3xxx alloy. Thus, at least for this reason, a 6xxx alloy need not necessarily be used for components such as inlet-side busbar holder 241, components 243 and 245 and outlet-side busbar holder 247.

In accordance with one or more embodiments, a second configuration shown in FIG. 4 provides corrosion resistance and brazeability similarly to the first configuration, but also provides a benefit of recyclability. As such, FIG. 4 provides essentially the same configuration as FIG. 3 with the exception of upper and lower coating layers for base plate 232 and support plate 228. Particularly, both base plate 232 and support plate 228 include an upper coating layer formed from alloy 1050 at 7.5% thickness, and a lower coating layer formed from alloy 7072 (zinc) at 10% thickness. Here, as well, the coating layers for base plate 232 and support plate 228 enhance brazeability in a manner to make up for any inherent disadvantage otherwise obtained for the lack of a core formed from a 3xxx alloy. Thus, depending on the desired operating context, alloy 7072 may be considered as a suitable substitute for the 3xxx alloy and zinc shown in FIG. 3, still providing a degree of corrosion protection while facilitating recyclability.

In accordance with one or more embodiments, three variant configurations as shown in FIGS. 5-7 facilitate the use of adhesive instead of brazing between channel plate 230 and support plate 228. All differ from the second configuration (FIG. 3) solely by way of the coating layers used for base plate 232, channel plate 230 and support plate 228. Generally, in each of the configurations shown in FIGS. 5-7, base plate 232 and channel plate 230, as the main constituent components of heat exchanger plate 210, still benefit from a strong interconnection brought about via brazing. At the same time, the adhesive connection between channel plate 230 and support plate 228 still is beneficial but helps reduce the brazing cycle and thus saves time in manufacturing. In this connection, it should be understood that as the support plate 228 forms no part of any liquid channels, there is no associated risk of leakage thus the adhesive connection indeed may be considered adequate. Any of a great variety of suitable adhesives may be utilized here, including thermally conductive adhesives

As such, in accordance with one or more embodiments, in the third configuration shown in FIG. 5, base plate 232 includes upper and lower coating layers formed from alloy 1050 at 7.5% thickness, an a second lower coating layer (adjacent the first coating layer) formed from brazing material (alloy 4045) at 5% thickness. Further, channel plate 230 only includes a core layer of alloy 3xxx and an upper coating layer of alloy 7072 at 5% thickness. Finally, support plate 228 includes the core layer of alloy 6xxx and an upper layer of adhesive.

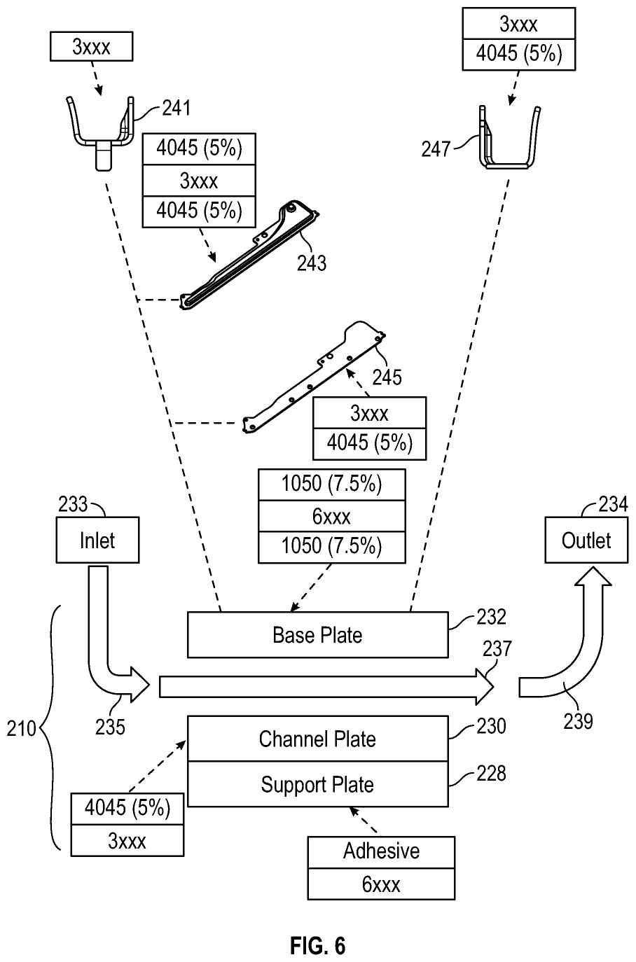

In accordance with one or more embodiments, the fourth configuration shown in FIG. 6 is substantially the same as the third configuration (FIG. 5) except for the configuration of base plate 232 and channel plate 230. Particularly, base plate 232 here only includes the core layer of alloy 6xxx and upper and lower coating layers of alloy 1050, while channel plate 230 includes brazing material (alloy 4045) as an upper layer at 5% thickness.

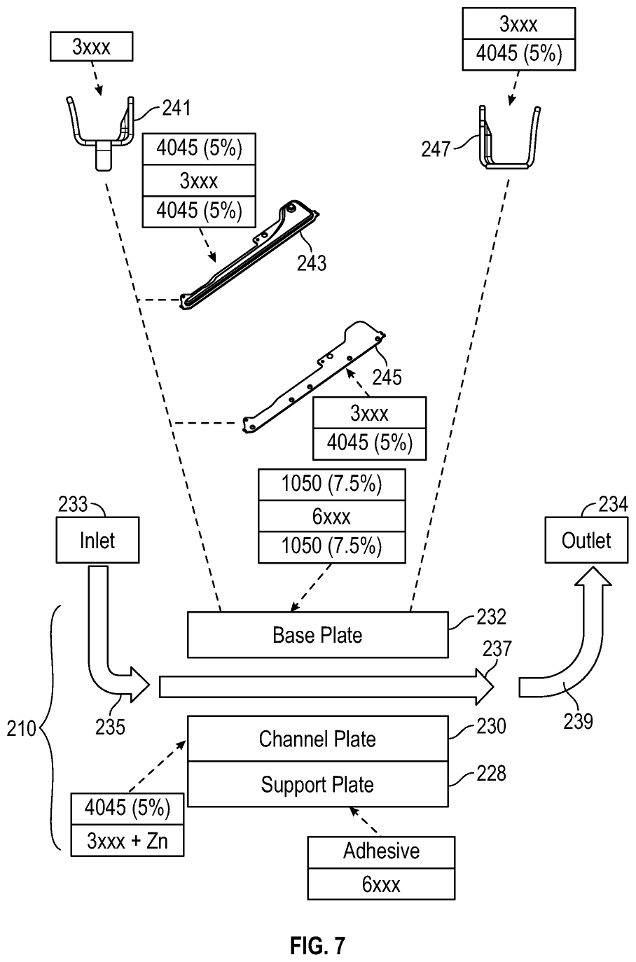

In accordance with one or more embodiments, the fifth configuration shown in FIG. 7 is substantially the same as the fourth configuration (FIG. 6) except for the configuration of channel plate 230. Particularly, the core of channel plate 230 here includes zinc in addition to alloy 3xxx.

Generally, it can be appreciated from the foregoing that the configurations described and illustrated with respect to FIGS. 2-7 each include inherent advantages that may be deemed beneficial for an operating context at hand. The use of 6xxx alloys in place of 3xxx, in particular, enhances recyclability by comparison. Additionally, as other components in a vehicle at hand may also utilize a 6xxx alloy, tools utilized in a disassembly and recovery process for the vehicle can also be applied to a battery pack including the alloy.

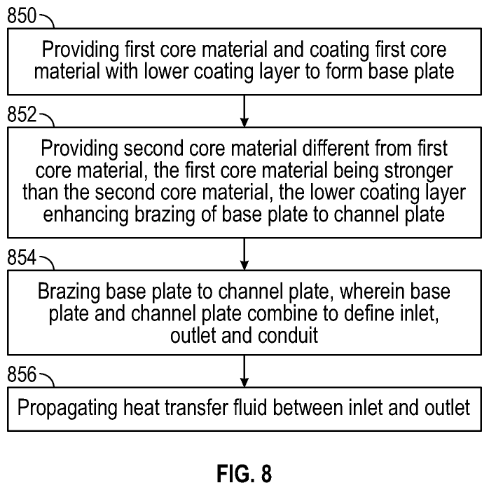

FIG. 8 provides a flowchart of a method in accordance with one or more embodiments. Specifically, FIG. 8 describes a method of making a heat exchanger plate. One or more blocks in FIG. 8 may be performed using one or more components as described in FIGS. 1-7. While the various blocks in FIG. 8 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

As such, in accordance with one or more embodiments, a first core material is provided and the first core material is coated with a lower coating layer to form a base plate (Step 850). This can correspond to the base plate 232 as shown in FIGS. 2-7, with a core material that may include alloy 6xxx and a lower coating layer that may include an aluminum alloy. A second core material, different from the first core material, is provided to form a channel plate; the first core material is stronger than the second core material and the lower coating layer enhances brazing of the base plate to the channel plate (Step 852). This can correspond to the channel plate 230 illustrated in FIGS. 2-7. The base plate is brazed to the channel plate, whereby the base plate and channel plate combine to define an inlet, an outlet, and a conduit (Step 854). This can be appreciated, by way of illustrative example, via the combination of base plate 232 and channel plate 230 shown in FIGS. 2-7, along with the brazing material utilized such as the 4045 alloy. Further, heat transfer fluid is propagated between the inlet and the outlet (Step 856). This can be appreciated, by way of illustrative example, via the flow arrows 235, 237 and 239 shown in FIGS. 2-7.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed:

1. A heat exchanger plate for thermal management of one or more battery packs, the heat exchanger plate comprising:
a base plate comprising a first core material and a lower coating layer that coats the first core material; and
a channel plate disposed adjacent to the base plate, the channel plate comprising at least one channel formed therein and a second core material different from the first core material,
wherein the base plate and channel plate combine to define an inlet, an outlet, and a conduit for propagating heat transfer fluid between the inlet and the outlet, and
wherein the first core material is stronger than the second core material and the lower coating layer enhances brazing of the base plate to the channel plate.

2. The heat exchanger plate according to claim 1, wherein the first core material is an aluminum alloy.

3. The heat exchanger plate according to claim 2, wherein the first core material is a 6xxx alloy.

4. The heat exchanger plate according to claim 3, wherein the second core material is an aluminum alloy.

5. The heat exchanger plate according to claim 4, wherein the second core material is a 3xxx alloy.

6. The heat exchanger plate according to claim 2, wherein the lower coating layer comprises an aluminum alloy.

7. The heat exchanger plate according to claim 6, wherein the lower coating layer is formed from a 3xxx alloy and zinc.

8. The heat exchanger plate according to claim 6, wherein the lower coating layer is formed from a 7072 alloy.

9. The heat exchanger plate according to claim 6, wherein the lower coating layer is formed from a 1050 alloy.

10. The heat exchanger plate according to claim 1, further comprising:
a support plate disposed adjacent to the channel plate,
wherein the support plate includes a core formed from the first core material and an upper coating layer that coats the core.

11. The heat exchanger plate according to claim 10, wherein the upper coating layer enhances brazing of the base plate to the channel plate.

12. The heat exchanger plate according to claim 11, wherein the upper coating layer comprises an aluminum alloy.

13. The heat exchanger plate according to claim 10, wherein the upper coating layer comprises an adhesive.

14. The heat exchanger plate according to claim 1, wherein the battery packs are for a hybrid or electric vehicle.

15. A battery unit for a hybrid or electric vehicle, the battery unit comprising:
a battery pack; and
a heat exchanger plate for thermal management of the battery pack, the heat exchanger plate comprising:
a base plate comprising a first core material and a lower coating layer that coats the first core material; and
a channel plate disposed adjacent to the base plate, the channel plate comprising at least one channel formed therein and a second core material different from the first core material;
wherein the base plate and channel plate combine to define an inlet, an outlet, and a conduit for propagating heat transfer fluid between the inlet and the outlet,
wherein the first core material is stronger than the second core material and the lower coating layer enhances brazing of the base plate to the channel plate.

16. The battery pack according to claim 15, wherein the first core material is an aluminum alloy.

17. The battery pack according to claim 16, wherein the first core material is a 6xxx alloy.

18. The battery pack according to claim 16, wherein the lower coating layer comprises an aluminum alloy.

19. The battery pack according to claim 15, further comprising:
a support plate disposed adjacent to the channel plate;
wherein the support plate includes a core formed from the first core material and an upper coating layer that coats the core.

20. A method comprising:
providing a first core material and coating the first core material with a lower coating layer to form a base plate; and
providing a second core material different from the first core material, the first core material being stronger than the second core material, to form a channel plate with at least one channel disposed therein, wherein the lower coating layer enhances brazing of the base plate to the channel plate;
brazing the base plate to the channel plate, wherein the base plate and channel plate combine to define an inlet, an outlet, and a conduit; and
propagating heat transfer fluid between the inlet and outlet via the conduit.
